(19) United States
(12) Patent Application Publication
(10) Pub. No.: US 2004/0047039 A1
(43) Pub. Date: Mar. 11, 2004

(54) Wide angle optical device and method for making same

(76) Inventors: Jian Wang, Orefield, PA (US); Xuegong Deng, Piscataway, NJ (US)

Correspondence Address: REED SMITH LLP, 2500 ONE LIBERTY PLACE, 1650 MARKET STREET, PHILADELPHIA, PA, 19103, US

(21) Appl. No.: 10/463,463

(22) Filed: Jun. 17, 2003

Related U.S. Application Data
(60) Provisional application No. 60/389,224, filed on Jun. 17, 2002.

(51) Int. Cl. G02B 5/30; G02B 27/28

(52) U.S. Cl. 359/487

(57) ABSTRACT

The present invention is directed to a device for reflecting a select polarization of at least one transmission having a given wavelength impinging upon the device. The device includes a substrate and a layer of nanostructures. The nanostructures form a resonant pattern on the substrate adapted to define a plurality of high contrast refractive index interfaces suitable for reflecting the select polarization of the at least one transmission.

### CROSS REFERENCE TO RELATED APPLICATIONS

This application claims priority of U.S. Patent Application Serial No. 60/389,224 filed on Jun. 17, 2002, entitled “Optical Device and Method of Making Same,” the entire disclosure of which is incorporated herein, as if set forth in its entirety.

### FIELD OF THE INVENTION

The present invention relates generally to optical components being suitable for forming or including polarizing mirrors, mirrors, beam splitters, combiners, and/or array optics.

### BACKGROUND OF THE INVENTION

Broadband mirrors have important applications in photonics and optoelectronics. Conventionally there are two methods of producing mirrors: (1) using a surface of a metal layer, and (2) using multilayer dielectric films. Metal layers generally provide robust performance with respect to angle of incidence properties, wavelength dependence, and polarization characteristics. However, a major limitation stems from nonuniform reflectivity of metal materials across different wavelength bands. Further, wavelength selectivity may be difficult to achieve using metal layers. On the other hand, multilayer dielectric interference mirrors may provide high reflectivity and wavelength-selectivity. However, multilayer dielectric interference mirrors generally lack good performance qualities with respect to angle of incidence, and typically require alternating layers of materials having relatively high and low refractive indices, respectfully.

### SUMMARY OF THE INVENTION

A device for reflecting a select polarization of at least one transmission of a given wavelength impinging upon the device, the device including: a substrate; and, at least two layers of nanostructures forming a resonant pattern on the substrate adapted to define a plurality of high contrast refractive index interfaces being suitable for reflecting the select polarization of the at least one transmission.

### BRIEF DESCRIPTION OF THE FIGURES

Understanding of the present invention may be facilitated by consideration of the following detailed description of the preferred embodiments of the present invention taken in conjunction with the accompanying drawings, in which like numerals refer to like parts and:

FIG. 1A illustrates a cross-sectional view of a resonant mirror according to an aspect of the present invention;

FIG. 1B illustrates a cross-sectional view of a resonant mirror exhibiting polarization independent properties according to an aspect of the present invention;

FIG. 2A illustrates a top view of the resonant mirror shown in FIG. 1A, according to an aspect of the present invention;

FIG. 2B illustrates a top view of a resonant mirror according to an aspect of the present invention.

FIG. 3 illustrates a cross-sectional view of a resonant mirror according to an aspect of the present invention;

FIG. 4 illustrates a cross-sectional view of a resonant mirror according to an aspect of the present invention;

FIG. 5 illustrates a relationship between the effective index, the birefringence and the filling ratio for different polarization states for the resonant mirror embodied in FIG. 1A;

FIG. 6 illustrates a relationship between transmission/reflection and wavelength for different polarization states for the resonant mirror embodied in FIG. 1A;

FIG. 7 illustrates the relationship of polarization-dependent extinction ratios for the resonant mirror embodied in FIG. 1A;

FIG. 8 illustrates a relationship between transmission/reflection and wavelength for different polarization states for the resonant mirror embodied in FIG. 3;

FIG. 9 illustrates a plot of the reflection of TE as a function of wavelength and incident angle for two one-dimensional layers of a device according to an aspect of the present invention such as is shown in FIG. 4;

FIG. 10 illustrates a plot of the transmission of TM as a function of wavelength and incident angle for two one-dimensional layers of a device according to an aspect of the present invention such as is shown in FIG. 4;

FIG. 11 illustrates a plot of the reflection of TE as a function of wavelength and incident angle for three one-dimensional layers of a device according to an aspect of the present invention such as is shown in FIG. 4;

FIG. 12 illustrates a plot of the reflection of TE as a function of wavelength and incident angle for four one-dimensional layers of a device according to an aspect of the present invention such as is shown in FIG. 4;

FIG. 13 illustrates the relationship between layer thickness, wavelength and reflection of TE for the structure of FIG. 4;

FIG. 14 illustrates the relationship between period of the structure, wavelength and reflection of TE for the structure of FIG. 4;

FIG. 15A illustrates a cross-sectional view of a device incorporating the device of FIG. 1A or 3;

FIG. 15B illustrates a top view of the device shown in the cross-sectional view of FIG. 8A, according to an aspect of the present invention;

FIG. 16 illustrates a cross-sectional view of a wavelength filter according to an aspect of the present invention incorporating the resonant grating shown in FIG. 4;

FIG. 17 illustrates a simulated performance of the wavelength filter illustrated in FIG. 16 according to an aspect of the present invention;

FIG. 18 illustrates a simulated performance of the wavelength filter illustrates in FIG. 16 according to an aspect of the present invention;

FIG. 19A illustrates a device suitable for incorporating with the device from FIG. 1A or 3;

FIG. 19B illustrates a device incorporating the device from FIG. 19A and the device from FIG. 1A or 3;

FIG. 19C illustrates a bottom view of the device shown in FIG. 19B;

FIG. 20 illustrates a device incorporating the device of FIG. 19;

FIG. 21 illustrates a device suitable for use with the device of FIG. 20;

FIG. 22A illustrates a perspective view of a device incorporating the device of FIGS. 20 and 21;

FIG. 22B illustrates a cross sectional view of a device incorporating the device of FIGS. 20 and 21; and,

FIG. 23 illustrates a guiding device according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical photonic components and methods of manufacturing the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

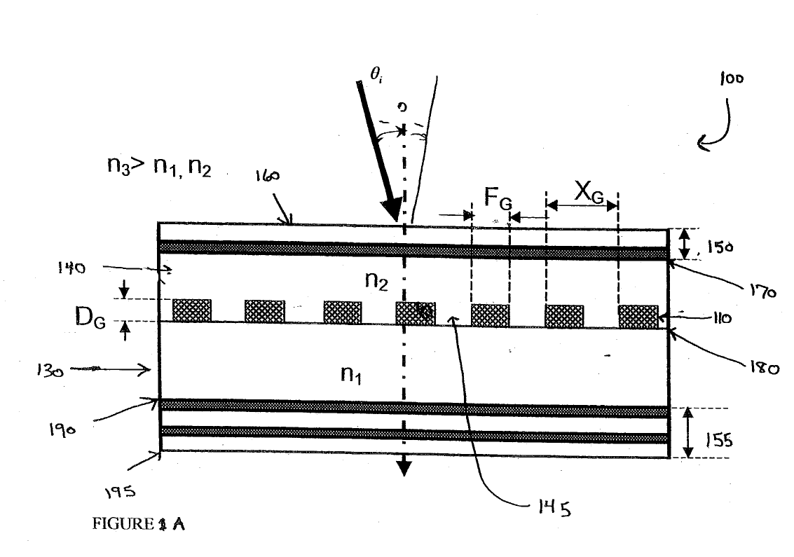

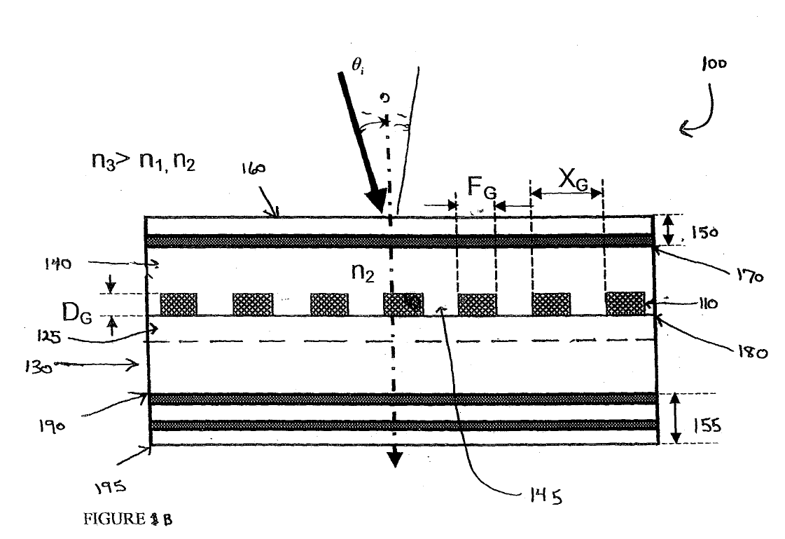

Referring now to FIG. 1A, there is shown a cross-sectional view of a resonant mirror 100 according to an aspect of the present invention. Resonant mirror 100 may include a substrate 130, a pattern of nanostructures 110, a cladding layer 140 and anti-reflection coatings 150, 155.

As shown in FIG. 1A, pattern of subwavelength elements such as nanoelements or nanostructures 110 may be formed on a surface of substrate 130. Nanostructures 110 may have dimensions in the range 0.1 nm to 1000 nm. An interface 180 may be created between substrate 130 and pattern of nanostructures 110. Cladding layer 140 may be added distal to interface 180 on pattern of nanostructures 110. Anti-reflection coating 150 may be formed on a surface of the cladding layer 140 distal from interface 180, thereby creating interface 170 there between. A surface of anti-reflection coating 150 distal to interface 170 may form an interface 160. Anti-reflection coating 155 may be applied to a surface of substrate 130 distal to interface 180, thereby creating interface 190 therebetween. The surface of anti-reflection coating 155 distal to interface 190 may form an interface 195.

Resonant mirror 100 may be made from materials suitable for use in optics and known by those possessing ordinary skill in the pertinent arts. In forming resonant mirror 100 high contrast refractive index interfaces providing high reflectivity by regions within nanostructures 110. Suitable materials may include materials commonly used in the art of grating or optic manufacturing such as glass (like BK7, Quartz and Zerodur, for example), semiconductors, and polymers, including for example GaAs/AlGaAs, GaAs/AlAs, Si/SiO₂ and SiNₓ/SiO₂ pairs, for example. According to an aspect of the present invention, an underlying one-dimensional (1-D) pattern of nanostructures 110, preferably formed of materials of high contrast reflective index may be formed on substrate 130. According to an aspect of the present invention, two-dimensional (2-D) pattern of nanostructures 110, preferably formed of materials of high contract refractive index may be formed on substrate 130.

Referring now also to FIG. 1B, there is shown a resonant mirror according to an aspect of the present invention. Resonant mirror 100 as discussed hereinabove may include a lower cladding layer 125 included as a portion of substrate 130. However, lower cladding layer 125 may be a separate layer from substrate 130. If a separate lower cladding layer 125 is utilized, pattern of nanostructures 110 may be replicated into lower cladding layer 125. Inclusion of separate lower cladding layer 125 may lessen the constraint that the materials of substrate 130 may be suited for replication, possibly a strict constraint depending on the technique used for replicating. Lower cladding layer 125 may take these properties and therefore substrate 130 may be any suitable material and may not be constrained by properties required for replication. Lower cladding layer 125 and the substrate 130 may be included within the discussion as substrate 130 while it is known that these may be separate layers.

Pattern of nanostructures 110 may include multiple sub-wavelength elements each of width F_{G} and height D_{G}. Pattern of nanostructures 110 may have a period of nanostructures, X_{G}. The filling ratio of pattern of nanostructures 110, denoted F_{G}/X_{G}, is the ratio of the width of the higher index area within the period to the overall period. Filling ratio, F_{G}/X_{G}, may determine the operation wavelength, as would be evident to one possessing an ordinary skill in the pertinent arts.

According to an aspect of the present invention, resonant mirror 100 may reflect or pass transmissions in a certain frequency range depending on the polarization state of the waves as they impinge upon pattern of nanostructures 110.

Pattern of nanostructures 110 may be formed into or onto substrate 130 using any suitable process for replicating, such as a lithographic process. For example, nanoimprint lithography consistent with that disclosed in U.S. Pat. No. 5,772,905, entitled NANOIMPRINT LITHOGRAPHY, the entire disclosure of which is hereby incorporated by reference as if being set forth in its entirety herein, may be used. This patent teaches a lithographic method for creating ultra-fine patterns of nanostructures 110, such as sub 25 nm, in a thin film coated on a surface. For purposes of completeness, a mold having at least one protruding feature may be pressed into the thin film applied to substrate 130. The at least one protruding feature in the mold creates at least one corresponding recess in the thin film. After replicating, the mold may be removed from the film, and the thin film processed such that the thin film in the at least one recess may be removed, thereby exposing an underlying pattern or set of devices. Thus, the patterns in the mold are replicated in the thin film, and then the patterns replicated into the thin film are transferred into the substrate 130 using a method known to those possessing an ordinary skill in the pertinent arts, such as reactive ion etching (RIE) or plasma etching, for example. Of course, any suitable method for forming a structure into or onto an operable surface, such as the substrate, may be utilized though, such as photolithography, holographic lithography, e-beam lithography, for example. Substrate 130 may take the form of silicon dioxide with a thin film of silicon forming the pattern of nanostructures 110.

As will be recognized by those possessing ordinary skill in the pertinent arts, various patterns may be replicated onto substrate 130. These patterns may serve various optical or photonic functions. Such patterns may take the form of holes, strips, trenches or pillars, for example, all of which may have a common period or not, and may be of various or common heights and widths. The strips may be of the form of rectangular grooves, for example, or alternatively triangular or semicircular grooves. Similarly pillars, basically the inverse of holes, may be patterned. The pillars may be patterned with a common period in both axes or alternatively by varying the period in one or both axes. The pillars may be shaped in the form of, for example, elevated steps, rounded semi-circles, or triangles. The pillars may also be shaped with one conic in one axis and another conic in the other. In an aspect of the present invention an underlying one-dimensional (1-D) pattern of nanostructures 110, preferably formed of materials of high contrast reflective index may be formed on substrate 130. This 1-D pattern may be of the form of trenches, for example. According to an aspect of the present invention, two-dimensional (2-D) pattern of nanostructures 110, preferably formed of materials of high contract refractive index may be formed on substrate 130. This 2-D pattern may be of the form of pillars, for example.

As is known in the pertinent arts, transmissions impinging on a high contrast refractive index boundary either reflects, or transmits, or a combination thereof, depending on properties of the transmission including frequency range or wavelength and polarization. Angle relationships for both reflection and refraction may be derived from Fermat's principle. Of course, reflection may be defined as the return of radiation by a surface, without a change in wavelength and may be commonly defined by the “law of reflection”. Refraction of the transmission may be predominately governed by Snell's Law, which relates the refractive indices on both sides of the interface to the directions of propagation in terms of the angles to the normal of the surface. Refraction may be the bending of oblique incident rays as they pass from a medium having one refractive index into a medium with a different refractive index. Of course, the refractive index is the speed of light in vacuum divided by the speed of light in the medium. Because the refractive index is a function of wavelength, the angle of the refracted transmission and the quantity of transmission reflected and refracted are a function of the wavelength. In general, the interaction of transmissions and mediums as a function of the wavelength of the transmission is well known by those possessing skill in the pertinent arts.

As is known in the pertinent arts, high reflectivity may be achieved by utilizing multiple layers of alternating high contrast refractive indices. If a transmission impinges onto a structure consisting of multiple layers of such refractive indices, multiple reflections take place within the structure. As a general rule, the more properly designed layers, the higher the reflectivity as each new layer adds to the interacting reflected transmission. However, as set forth, multilayer films may generally not be robust to variations in angle of incidence of the transmission, though.

Substrate 130 may have a refractive index n₁ approximately equal to the refractive index n₂ of cladding layer 140. Refractive indices n₁ and n₂ may be on the order of approximately 1.5. This may serve to reduce undesirable refraction or reflection at interface 180 as transmissions pass therethrough. Of course, the greater the difference between these two refractive indices (n₁, n₂) the greater the reflection and refraction that may occur at interface 180 as defined by laws commonly known in the art, for example Snell's Law governing refraction and the Law of Reflection. Filling material 145 has a refractive index n_{F} approximately equal to refractive indices n₁ and n₂ thereby creating n_{F}≈n₁≈n₂. Filling material 145 may be positioned between the pattern of nanostructures 110 and may be deposited in this region between the high index gratings using methods known by those possessing an ordinary skill in the pertinent arts, such as physical vapor deposition (thermal evaporation, e-beam deposition, sputtering), chemical vapor deposition (CVD, LPCVD, PECVD, APCVD), reactive sputtering, and flame hydrolysis deposition (FHD).

Anti-reflection coatings (ARC) 150, 155 may be provided on one or both of interfaces 170, 190. In FIG. 1A, both ARC 150 and ARC 155 are included. ARCs 150, 155 generally decrease losses resulting from differences in refractive indices at interfaces 170 and 190. The use and manufacture of ARCs 150, 155 is well understood by those possessing an ordinary skill in the pertinent arts. Briefly, ARCs 150, 155 may include a single coating of a refractive index chosen to substantially eliminate reflections at a desired wavelength. ARCs 150, 155 may include multi-layer coatings to reduce losses over an expanded spectrum, or a spectrum in which the device or component is designed to be used. For purposes of completeness, anti-reflection coatings generally operate to create a double interface by means of a thin film by providing two reflected waves. If these waves are out of phase, they partially or totally cancel. For example, if coating 150 is a single quarter wavelength thickness having a refractive index less than the element that the coating coats, the two reflections created at each interface 160, 170 associated with ARC 150 are 180 degrees out of phase. In such a configuration, reflected waves are substantially the same amplitude and 180 degrees out of phase thereby substantially canceling each other out. As there is substantially zero reflected transmission, the law of conservation of energy holds that the transmitted transmission approaches 100% of the impinging transmission.

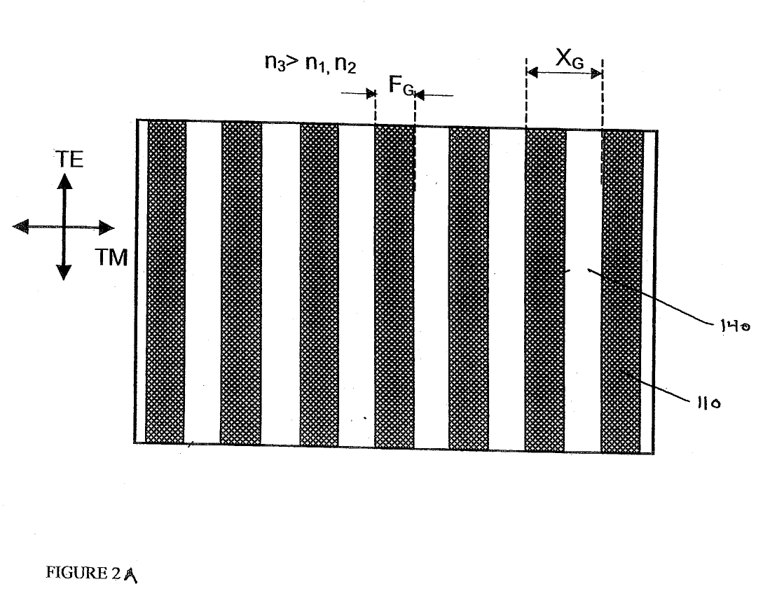

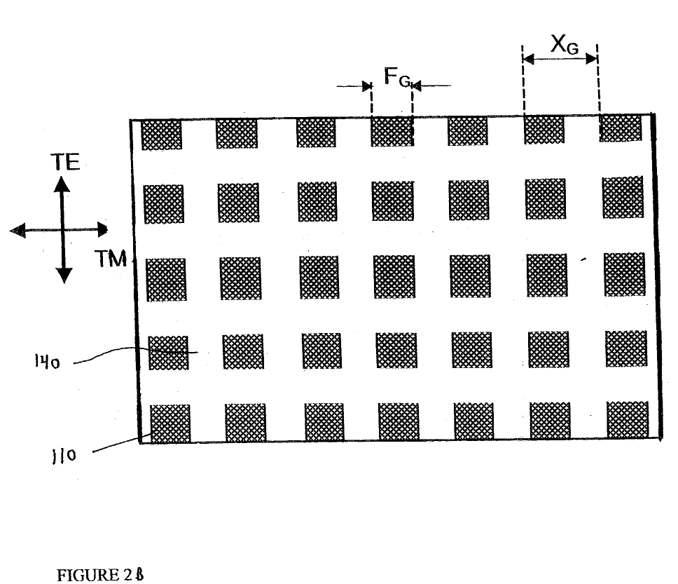

Referring now also to FIG. 2A, there is shown a top view of pattern of nanostructures 110 being suitable for use with the resonant mirror 100 of FIG. 1A. Pattern of nanostructures 110 may form an optical grating or grid structure. When a transmission impinges upon pattern of nanostructures 110, the grid structure transmits radiation with an E vector vibrating perpendicular to the grid (TM shown in FIG. 2A) and reflects radiation with an E vector vibrating parallel to the grid (TE shown in FIG. 2A).

Referring now also to FIG. 2B, there is shown a top view of pattern of nanostructures 110 being suitable for use with a resonant mirror. According to an aspect of the present invention, pattern of nanostructures 110 may form an array of pillars. When transmission impinges upon pattern of nanostructures 110, the pillar array may reflect and transmit the transmission without the polarization dependent effects that may result from a 1-D configuration, such as that shown in FIG. 1A.

Referring again to FIG. 1A, when transmissions impinge upon resonant mirror 100 at interface 160, the transmission may be reflected and refracted. The amount of the transmission reflected and refracted depends upon the factors discussed hereinabove, for example the refractive index of material in which the transmission was propagating, such as a core of an optical fiber or air for example, and the refractive index of ARC 150. If ARC 150 is provided, the quantity of reflected transmission resulting from interface 160 may be relatively small. The transmission portion refracted at interface 160 propagates through ARC 150 and impinges upon cladding layer 140 at interface 170. Again, this transmission is reflected and refracted at interface 170 with the quantity of each being dependent upon the refractive index of ARC 150 and n₂ (the refractive index of cladding layer 140) and other properties discussed herein above, for example. If ARC 150 is provided the reflected portion at interface 170 is likely to be small. Again, the refracted portion of the impinging transmission propagates through cladding layer 140 and impinges upon pattern of nanostructures 110.

The propagating transmission is reflected and refracted governed by the relationships discussed hereinabove, including between refractive indices n₂, n₃ and X_{G}, F_{G}, for example. Further, the transmission impinging upon pattern of nanostructures 110 may be governed by the physical property known in the art as diffraction. Of course, diffraction may be generally defined as the effect on transmission as a wavefront of transmission passes through an opening, such as for example an opening of pattern of nanostructures 110, as secondary wavefronts are generated apparently originating from the opening, interfering with the primary wavefront as well as with each other to form various diffraction patterns.

Additionally, the principle of multiple layer thin films, described hereinabove, is employed. The reflected radiation, vibrating parallel to the grid structure interacts with pattern of nanostructures 110, similar to the interaction of radiation and multilayer thin films, thereby enhancing reflectivity.

The refracted and diffracted transmission impinges upon substrate 130 of refractive index n₁ at interface 180. Again, this transmission may be reflected and refracted. The transmission refracted at interface 180 propagates through substrate 130 and impinges upon ARC 155, if present, at interface 190. Again, the transmission is reflected and refracted as defined above. Again, if ARC 155 is used the reflected transmission at interface 190 is likely to be small. Again, the refracted transmission propagates through ARC 155 to interface 195, where the transmission is reflected and refracted. If ARC 155 is used the reflected transmission at interface 195 is likely to be small. Finally, the transmitted portion refracted at interface 195 exits the resonant mirror into another medium, such as an optical fiber core or air, for example.

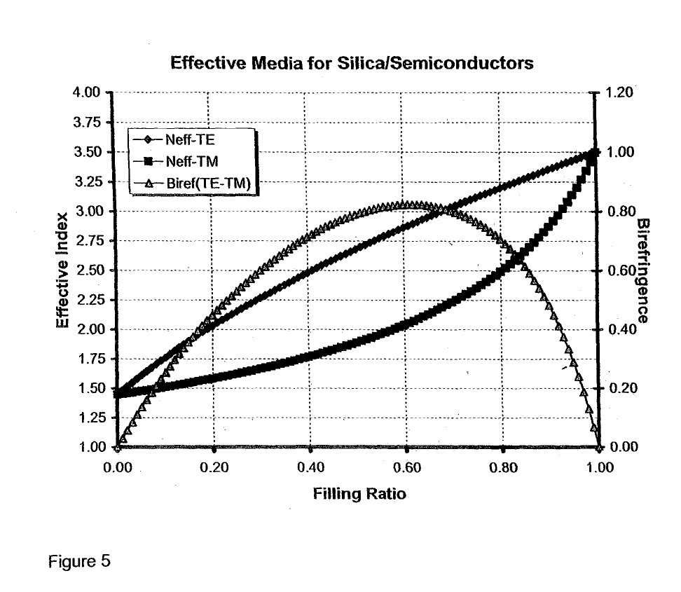

Thus, resonant mirror 100 may serve to select wavelengths and polarization thereby operating as a wavelength selecting polarization selective mirror 100. The resonant mirror 100 may be configured to perform broadband or narrowband wavelength selection, resulting in a resonant mirror 100 having a polarization-dependent forbidden band over certain wavelength ranges, for example. In particular, if the forbidden band for the transverse electric field (TE) is the allowed band for transverse magnetic field (TM) in the optical frequency range then the structure may be used to perform polarization beam splitting and/or combining. The forbidden band and pass band can be related to the quantities Xg and Fg, for example, through FIG. 5, discussed hereinbelow. For example, for refractive indices of the grating layers approximately equal to the refractive indices of the TM component, the reflections of the incident waves may be substantially zero. For the same structure, the TE component may encounter significant reflection due to the relatively higher indices of the grating layer. Thus one may create a polarization dependent transmission and reflection. Similarly, for mediums of higher indices of refraction, the TE component may become the transmission band and the TM component of the field may be reflected. Grating based polarization mirrors may permit incident angles to be varied from substantially 0 degrees to substantially 90 degrees. Thin film filter may be generally restricted to incident angles in the vicinity of the Brewster angle, which is generally larger than 30 degrees.

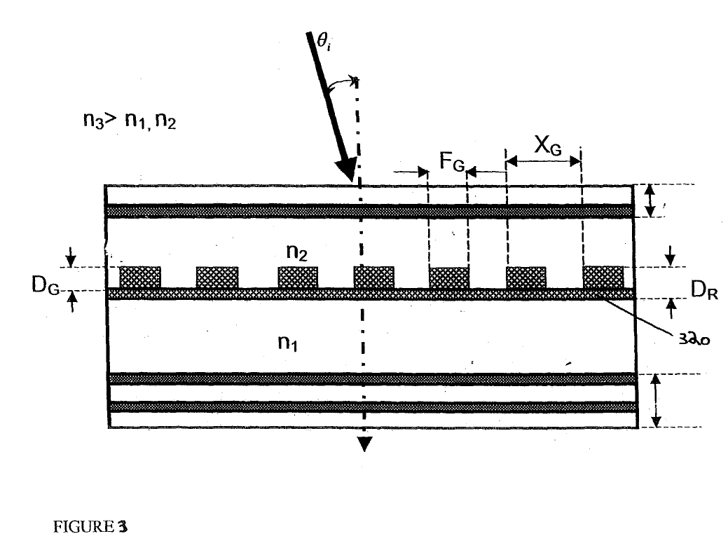

Referring now to FIG. 3, resonant mirror 100 may also have a residual layer 320 of refractive index n₃. Residual layer 320 may be placed between grating 110 and substrate 130 along interface 180. Residual layer 320 may increase the thickness of the n₃ refractive index region from D_{G} to D_{R}. Residual layer 320 may provide increased reflectivity and may be suited for use when resonant mirror 100 is used in reflection for example. Residual layer 320 may be used for a narrow-band mirror or filter, for example.

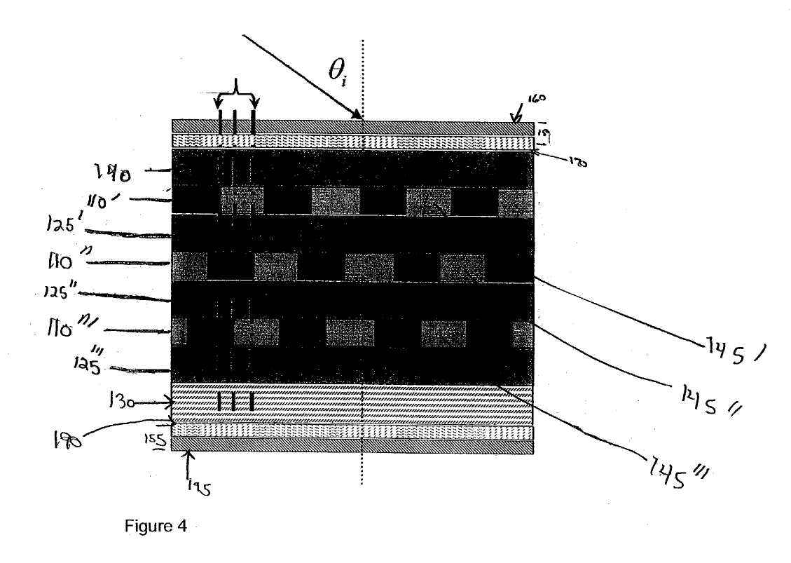

Referring now to FIG. 4, there is shown a resonant grating 400 suitable for accepting beams having a relatively wide angle of incidence according to an aspect of the present invention. Resonant grating 400 may include a substrate 130, a pattern of nanostructures 110 (or 110′-110′″), a cladding layer 140 and anti-reflection coatings 150, 155, as was described hereinabove with respect to FIG. 1A. Resonant grating 400 may also include a lower cladding layer 125. As may be seen in FIG. 4, resonant grating 400 may include additional layers of pattern 110 (shown as 110′, 110″, 110′″) and lower cladding layer 125 (shown as 125′, 125″, 125′″). The number of additional layers is by way of non-limiting example only and any suitable number of layers may of course be utilized. The additional layers of pattern 110 and lower cladding layer 125 may be oriented in a substantially co-planar relationship, in an alternating pattern, sequentially sandwiched, in a stacked configuration between cladding layer 140 and substrate 130, for example. As with pattern 110, each of the additional layers of pattern 110 (shown as 110′, 110″, 110′″) may include multiple nanostructures each of width F_{G} and height D_{G}. Elements of additional layers of pattern 110 (shown as 110′, 110″, 110′″) may also be chirped or varied. While, for ease of reference, each layer of nanostructures, is referred to as having elements of the same height and width, the elements within one layer may differ from the elements within other layers. As discussed hereinabove, one or more filling materials 145 may be positioned interspersed between the multiple nanostructures of width F_{G} and height D_{G} of pattern of nanostructures 110 (either 110′, 110″, 110′″) and may be deposited in this region between the high index elements using methods known by those possessing an ordinary skill in the pertinent arts. The elements of layer 110′ for example, may be substantially position insensitive to the elements of 110″ and similarly 110′″ as shown. Benefits gained by co-registering elements within patterns in the sandwich may be minimal. That is, one layer of elements 110, such as layer 110′, may not need to be registered with another layer 110, such as layer 110″ to achieve improved performance characteristics of reflectivity as compared to a single aligned layer 110.

Referring to FIG. 5, there is shown a relationship between the effective index, the birefringence and the filling ratio for different polarization states according to an aspect of the present invention. According to an aspect of the present invention n_{F}≈n₁≈n₂≈1.5 and n₃≈3.0. As will be recognized by those possessing an ordinary skill in the pertinent arts, the apparent refractive index for each of the polarization states is provided, as a function of the filling ratio.

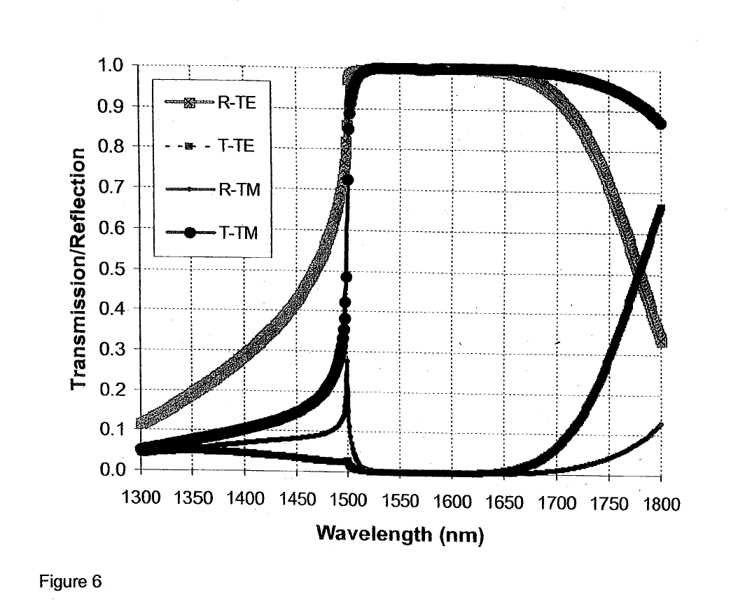

Referring to FIG. 6, there is shown a relationship between the transmission/reflection and wavelength for different polarization states according to an aspect of the present invention shown in FIG. 1A.

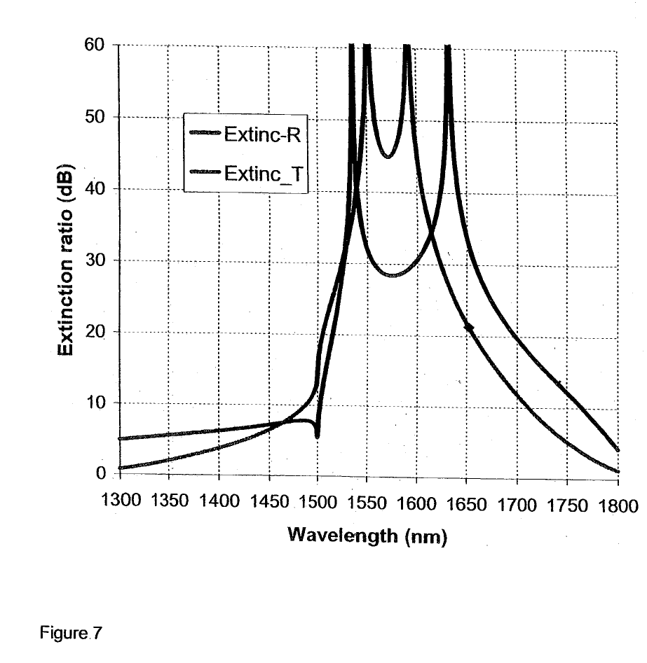

Referring to FIG. 7, there is shown a relationship of the polarization-dependent extinction ratios according to an aspect of the present invention shown in FIG. 1A.

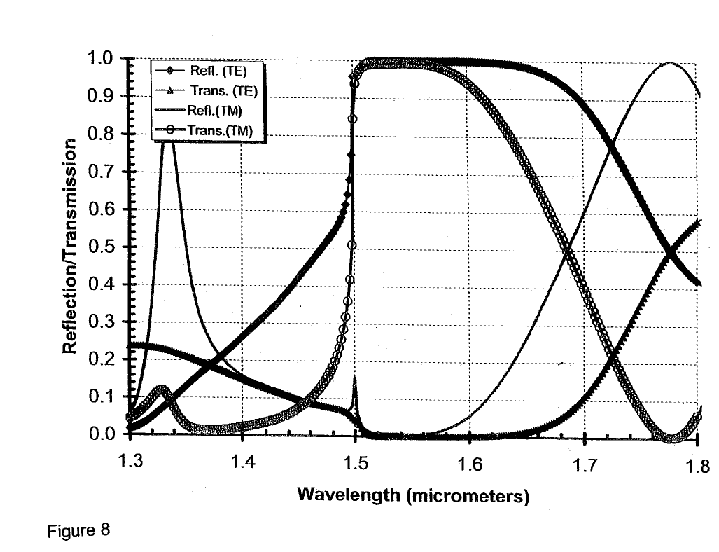

Referring to FIG. 8, there is shown a relationship between the transmission/reflection and wavelength for different polarization states according to an aspect of the present invention shown in FIG. 3 for the embodiment wherein the filling material may take the form of a semiconductor band material. Depicted in FIG. 8 there is shown the band structure as represented by the device in FIG. 3 with n₃≈3.5 and the geometrical parameters, period and thickness of the pattern of nanostructures and the index-loading rib in FIG. 3 designed such that the optical waves would be at resonant Bragg condition to the guiding mode.

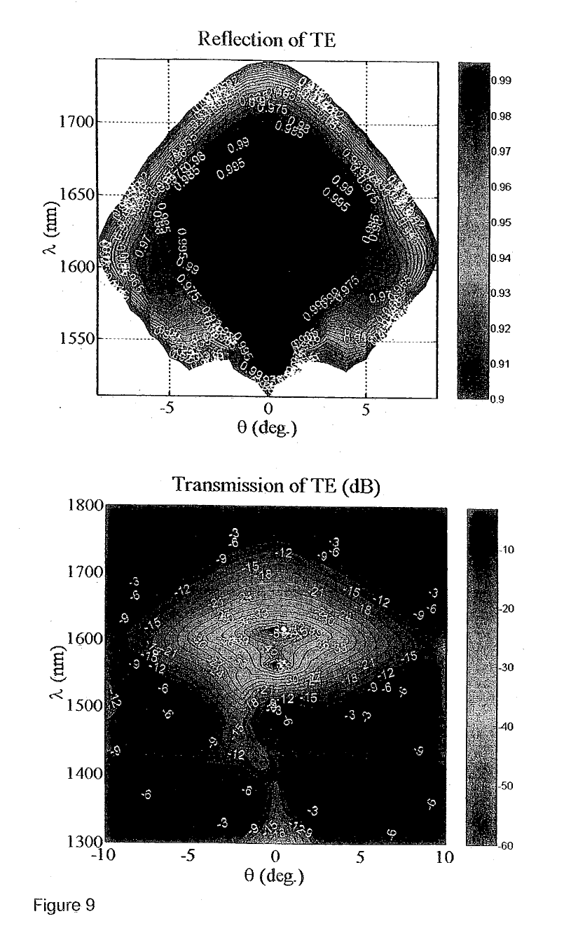

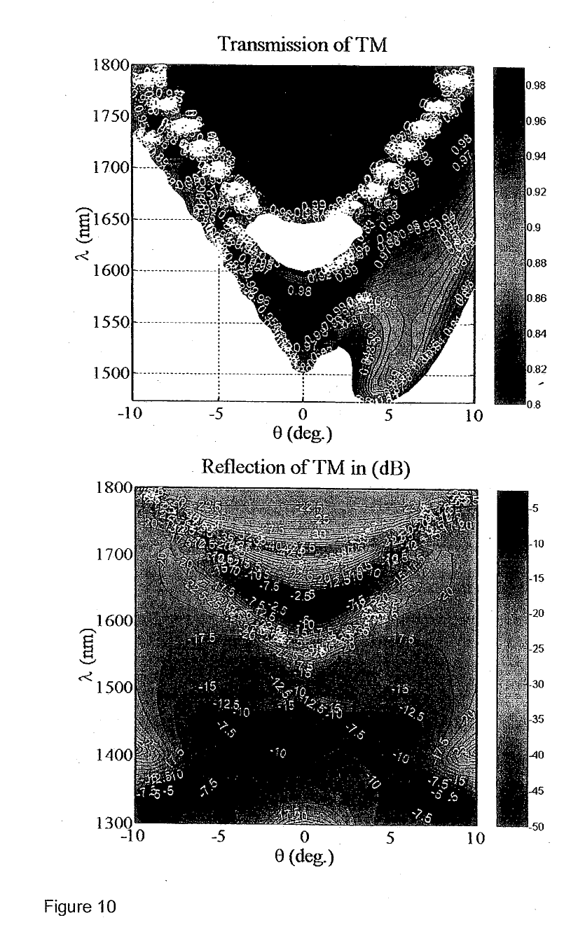

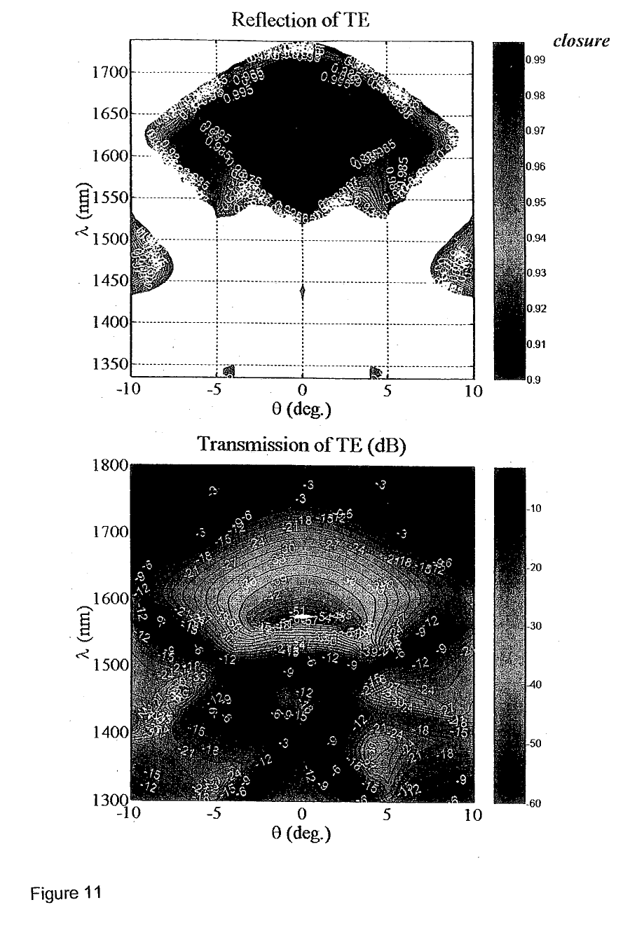

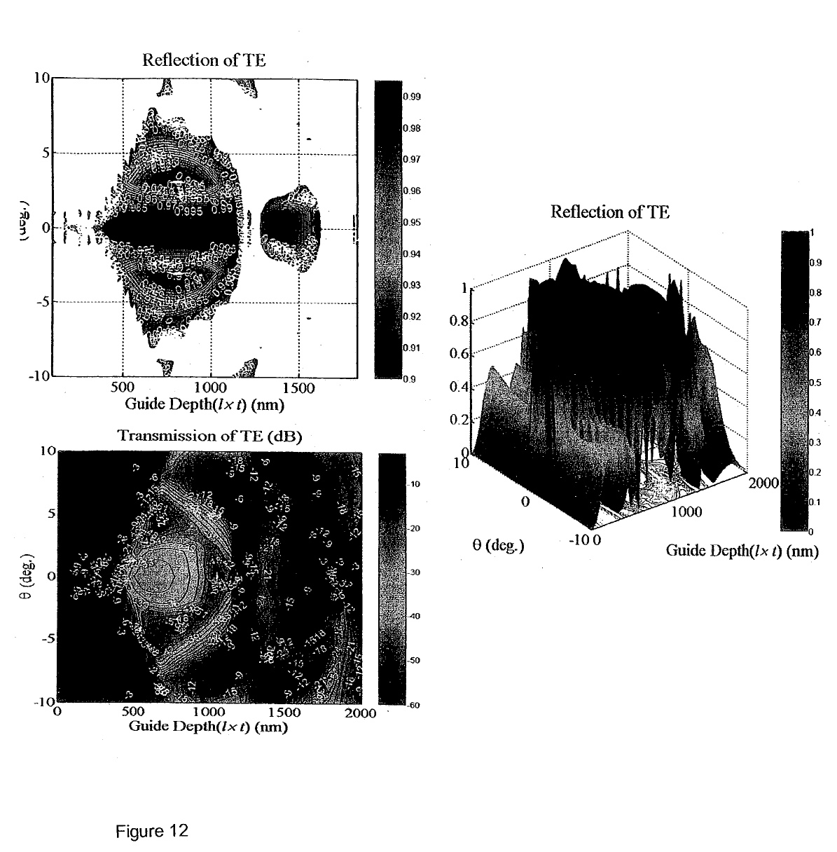

Referring now to FIGS. 9-11, there may be seen plots of reflection or transmission vs. wavelength and incident angle. As may be seen in FIG. 9, there is shown a plot of the reflection of TE as a function of wavelength and incident angle for two one-dimensional layers. As demonstrated in FIG. 9, incorporating two one-dimensional layers may serve to increase the accepted incident angle to ±5 degrees. As may be seen in FIG. 10, there is shown a plot of the transmission of TM as a function of wavelength and incident angle for two one-dimensional layers. As demonstrated in FIG. 10, incorporating two one-dimensional layers increases the accepted incident angle to ±5 degrees. Similarly, in FIG. 11, there is shown a plot of the reflection of TE as a function of wavelength and incident angle for three one-dimensional layers. As demonstrated in FIG. 11, incorporating three one-dimensional layers increases the accepted incident angle to ±5 degrees. Further, in FIG. 12, there is shown a plot of the reflection of TE as a function of wavelength and incident angle for four one-dimensional layers. As demonstrated in FIG. 12, incorporating four one-dimensional layers increases the accepted incident angle at least to ±5 degrees.

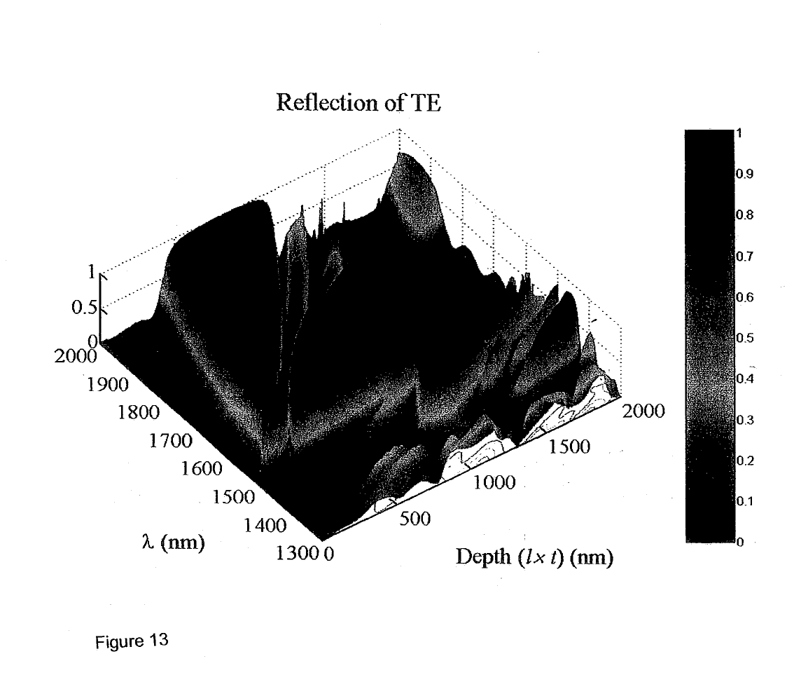

Now referring to FIG. 13, there is illustrated the relationship between layer thickness, wavelength and reflection of TE for the structure of FIG. 4. Specifically, in FIG. 13, the relationship between wavelength, in the range of 1.3 μm to 2.0 μm, layer thickness, in the range from 0 μm to 2 μm, and the associated change in the TE reflection varying from 0 to 1 is demonstrated. As is known to those possessing an ordinary skill in the pertinent arts, zero reflection refers to the instance when total absorption or transmission occurs and a reflection equal to 1 refers to complete reflection.

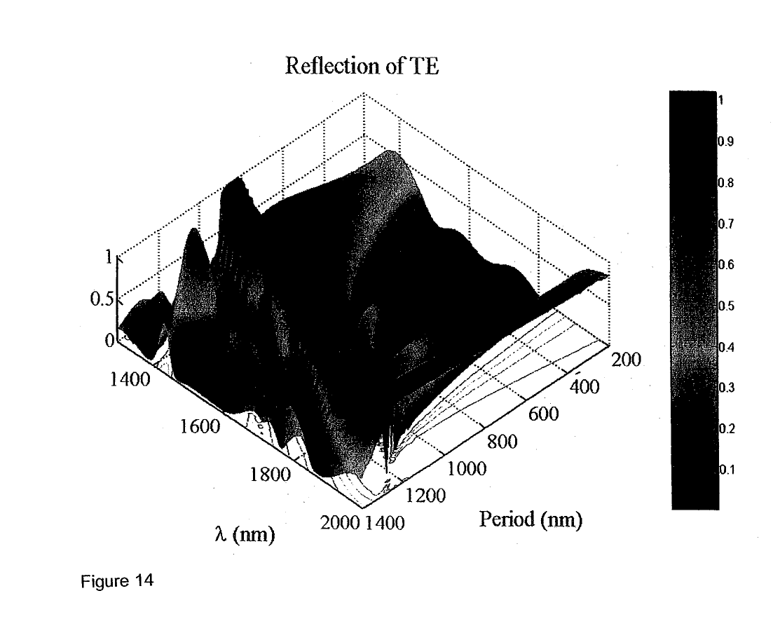

Now referring to FIG. 14, there is illustrated the relationship between period, X_{G}, of pattern of nanostructures 110, wavelength and reflection of TE for the structure of FIG. 4. Specifically, in FIG. 14, the relationship between wavelength, in the range of 1.3 μm to 2.0 μm, period, in the range of 0.2 μm to 1.4 μm, and the associated change in the TE reflection varying from 0 to 1 is demonstrated. As is known to those possessing an ordinary skill in the pertinent arts, zero reflection refers to the instance when total absorption or transmission occurs and a reflection equal to 1 refers to complete reflection. As may be seen in FIG. 14, wavelength of incident radiation and period, X_{G}, may be configured to provide the desired reflection of TE, such as for example, if a high reflection of TE is desired at 1200 nm, then a period of 800 nm may be selected.

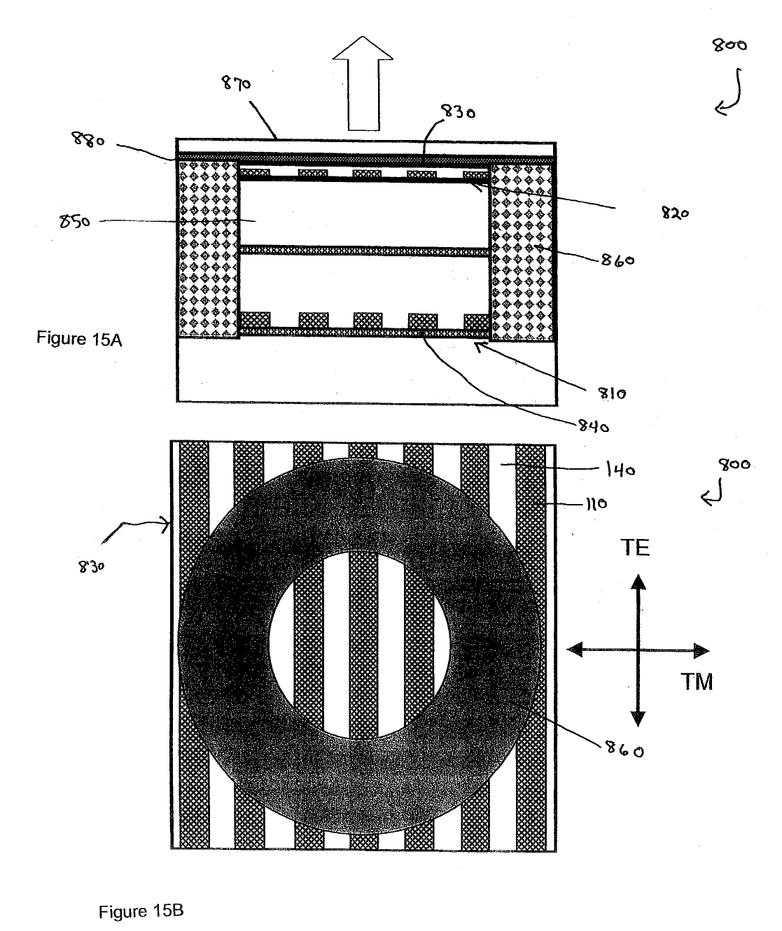

Referring now to FIGS. 15A and B, there is shown a device 800 incorporating resonant mirror 100. Device 800 may include a first substantially reflective device 810 and a second substantially reflective device 820 each incorporated at distal ends of cavity 850. Device 810 and/or 820 may take the form of device 100 of FIG. 1 or 3, for example. Device 800 may take the form of a type III-V semiconductor compound band vertical-cavity surface emitting laser (VCSEL), for example.

First substantially reflective device 810 may be oriented to reflect a desired polarization as described hereinabove. First substantially reflective device 810 may be additionally or alternatively configured to reflect a desired wavelength band, for example. Cavity 850 may be defined by an oxide/insulator confinement boundary 860. Second substantially reflective device 820 may be provided upon the distal end of cavity 850, with pattern of nanostructures 830 substantially aligned to pattern of nanostructures 840 of first substantially reflective device 810. Second substantially reflective device 820 may be designed to have a reflectivity slightly less than 1.0 with respect to desired polarization and wavelength band, thereby transmitting a portion of the energy resonant in cavity 850 with the desired polarization and desired wavelength band corresponding to first substantially reflective device 810. Use of first substantially reflective device 810 and second substantially reflective device 820 with cavity 850 and confinement 860 may produce a VCSEL with a preferred polarization direction and wavelength band. ARC 870 may be provided on one interface 880. As set forth, ARC 870, if provided, may generally decrease losses resulting from differences in refractive indices at interface 880.

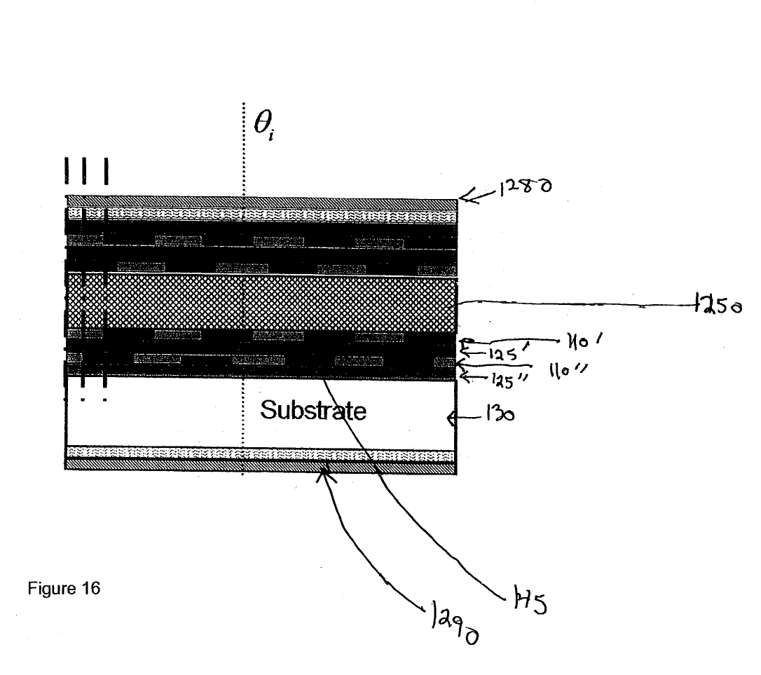

Referring now to FIG. 16, there is shown a wavelength filter 1600 incorporating the resonant grating shown in FIG. 4 which may be suited for accepting wide angle of incident beams according to an aspect of the present invention. As may be seen in FIG. 16, wavelength filter 1600 may include a substrate 130, a pattern of nanostructures 110, a cladding layer 140, as was described hereinabove with respect to FIGS. 1A and 4. As discussed with respect to FIG. 4, resonant grating 400 may include additional layers of pattern 110 (shown in FIGS. 4 and 16 as 110′, 110″), the number of additional layers is by way of non-limiting example only and any suitable number of layers may of course be utilized, and lower cladding layer 125 (shown in FIGS. 4 and 16 as 125′, 125″). As was discussed hereinabove additional layers of pattern 100 and lower cladding 125 may be oriented in a co-planar relationship, in an alternating pattern substantially sandwiched between cladding layer 140 and substrate 130. As with pattern 110, each of the additional layers of pattern 110 (shown as 110′, 110″) may include multiple nanostructures each of width F_{G} and height D_{G}. While, for ease of reference, each layer of nanostructures, is referred to as having elements of the same height and width, the elements within one layer may differ from the elements within other layers and may differ from other elements in same layer as well, for example elements of pattern 110 may also be chirped or varied. As discussed hereinabove, a filling material 145 may be positioned between pattern of nanostructures 110 (either 110′, 110″) and may be deposited in this region between the high index gratings using methods known by those possessing an ordinary skill in the pertinent arts. The elements of layer 110′ for example, may be position insensitive to the elements of 110″. Benefits gained by co-registering elements within patterns in the sandwich may be minimal.

Similar to the layers 110′, 110″ discussed hereinabove, a second series of patterns 1210, similar to series 110 may be located proximate to layers 110′, 110″ creating a cavity 1250 therebetween. Series of patterns 1210 may take the form, as discussed with respect to pattern 110, of multiple layers of patterns with cladding layers interspersed therebetween. Additionally, antireflection coatings 1280, 1290 may be added to reduce losses and reflections as will be known to those possessing an ordinary skill in the pertinent arts.

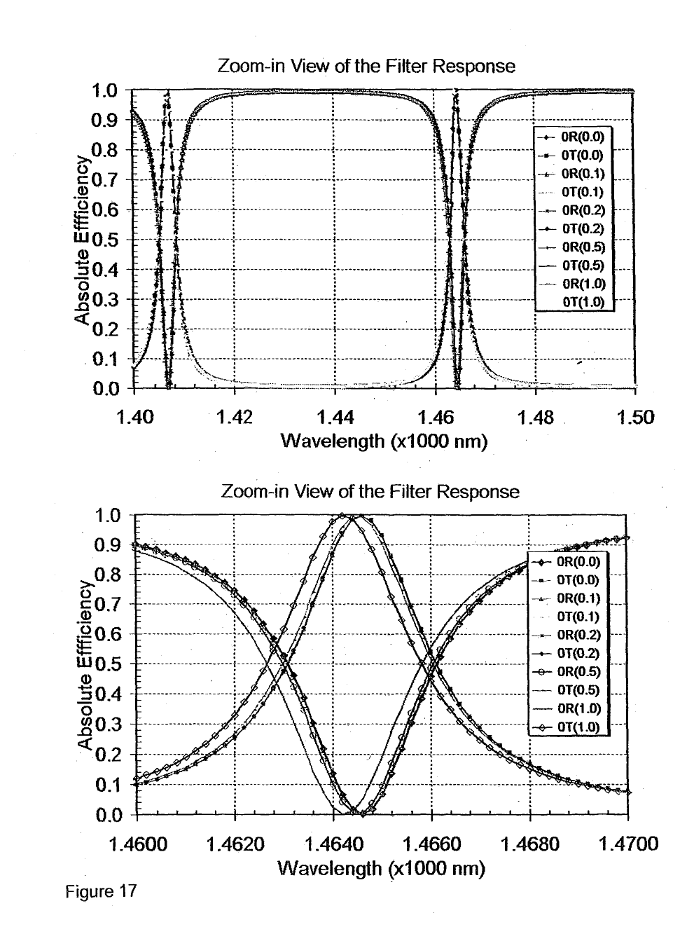

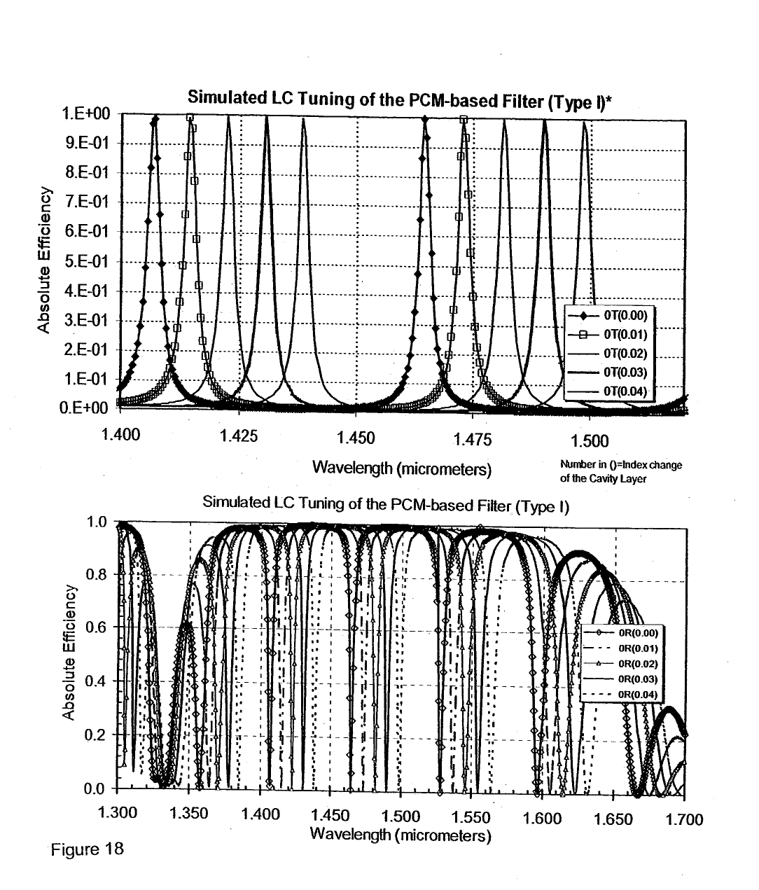

Referring now to FIG. 17, there is shown a simulated performance of wavelength filter 1600 of FIG. 16. As may be seen in FIG. 17, the simulated performance of the wavelength filter 1600 is plotted in absolute efficiency as a function of wavelength. As demonstrated by the results of FIG. 17, absolute efficiency may be maximized and may approach unity. Further, these reflectors of FIG. 16, may be designed to select a narrow bandwidth region of the incoming radiation, such as for example 1.4645 μm. Now referring also to FIG. 18, where there is shown a simulated performance of a tunable wavelength filter 1600 of FIG. 16. As may be seen in FIG. 18, the simulated performance of the wavelength filter 1600 tuning is plotted as a function of wavelength. The absolute efficiency of the PCM based filter of FIG. 16 is shown as a function of wavelength. The various curves simulate changes in the refractive index of layer 1250 shown in FIG. 16.

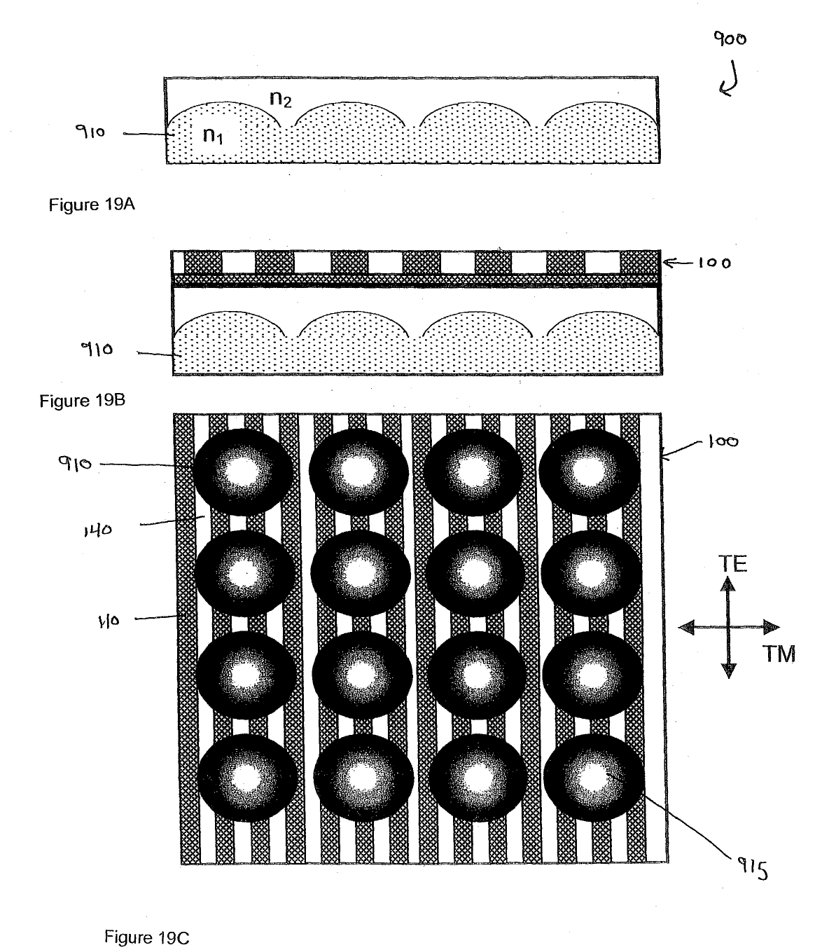

Referring now to FIGS. 19A, 19B, and 19C, a device 900 incorporating device 100 from FIG. 1 or 3 is shown. Device 900 may include micro-lenses 910 formed in an array 915 aligned to device 100 suitable for use as a polarization beam splitter and combiner (PBS/C). PBS/C 900 may be formed using a microlens 910, with a pitch size that is substantially uniform or varied to achieve desired results as will be recognized by those possessing an ordinary skill in the pertinent arts. Each micro-lens 910 may be of a form known to those having ordinary skill in the pertinent arts, such as refractive, diffractive, or hybrid, for example and may have a refractive index nₘ. Briefly, array 915 includes a plurality of micro-lenses 910 arranged in an ordered or desired pattern. Using micro-lens 910 array 915, each lens 910 may focus incident light on an individual area. In general, the use and design of micro-lens arrays is well known by those possessing skill in the pertinent arts. Resonant mirror 100 may be placed substantially the focal length of micro-lens 910 away from array 915, thereby having each lens 910 of array 915 focus on a corresponding portion of resonant mirror 100. Additionally, the device of FIG. 4 may also be used in the configuration of FIG. 19.

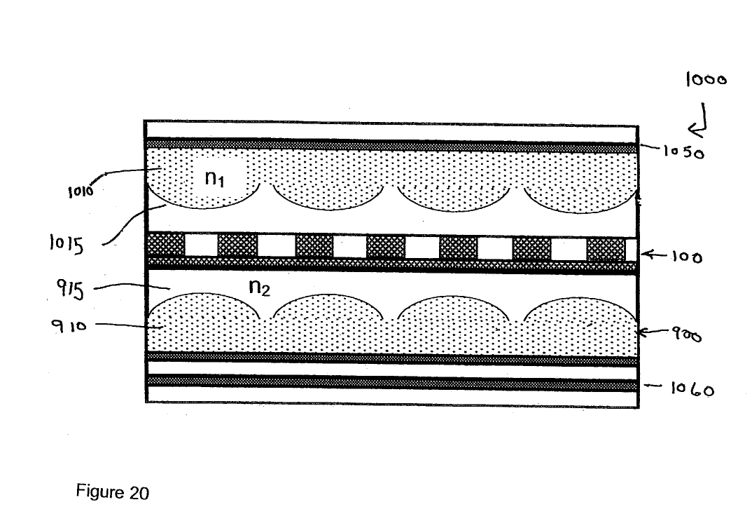

Referring now to FIG. 20, there is shown a device 1000 incorporating device 900 of FIG. 19. According to an aspect of the present invention, a second micro-lens 1010 array 1015 having a refractive index nm may be added to device 900. Second micro-lens 1010 array 1015 may be aligned on a surface of resonant mirror 100 distal to micro-lens array 915 for example. Micro-lens array 1015 may be aligned such that each lens 1010 array 1015 is substantially aligned to a corresponding lens 910 in a telecentric mode. An ARC 1050 may be applied to a surface of array 1015 distal to resonant mirror 100. Similarly, an ARC 1060 may be applied to a surface of array 915 distal to resonant mirror 100.

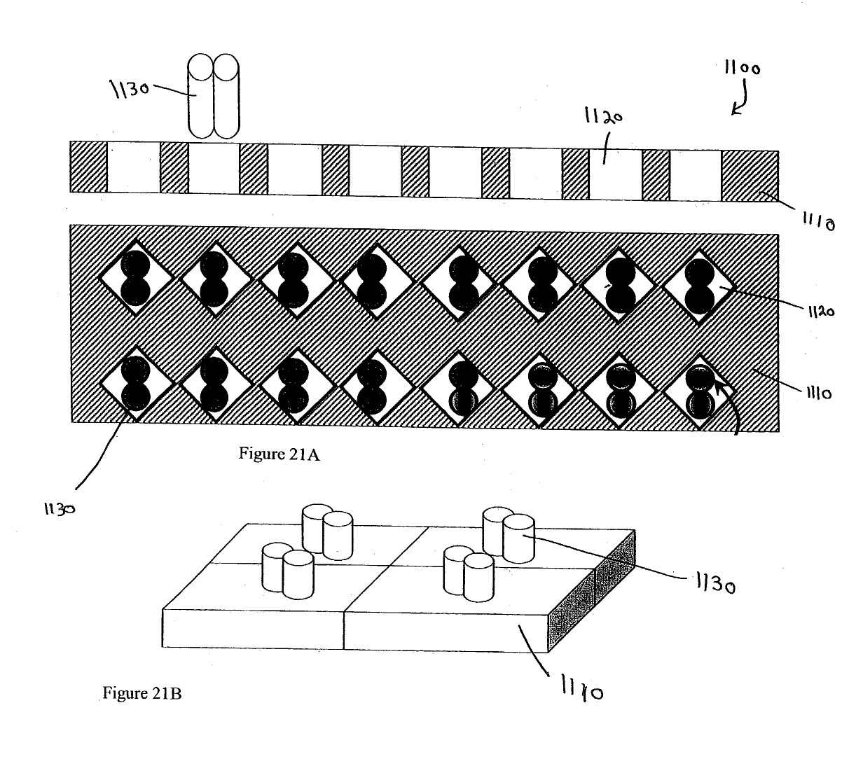

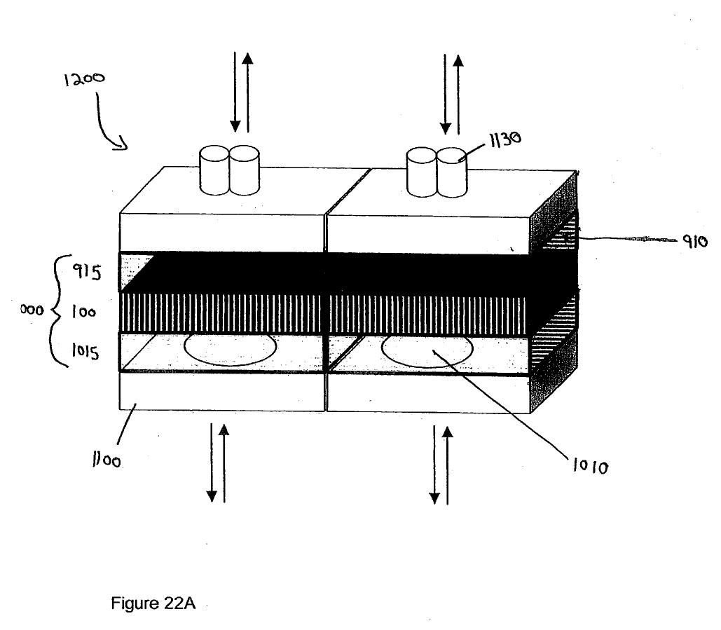

Referring now to FIGS. 21A and B, a device 1100 suitable for use with device 1000 of FIG. 20 is shown. Device 1100 may include a substrate 1110, and fibers 1130. In FIGS. 21A and B, there is shown a substrate 1110, for example a silicon wafer, lithographically patterned with selective portions 1120 etched through. Portions 1120 etched through may be sized to accept one or two single-mode or multi-mode fibers 1130, for example. Fibers 1130, which may be polished to optical flatness and may be AR coated, as known in the pertinent arts, may be fed through etched portions 1120 and fixed in place. Polarization maintaining fibers 1130 may be used for example, and two orthogonal axes of the polarization maintaining fibers 1130 may be aligned into orthogonal positions inside each etched portion 1120.

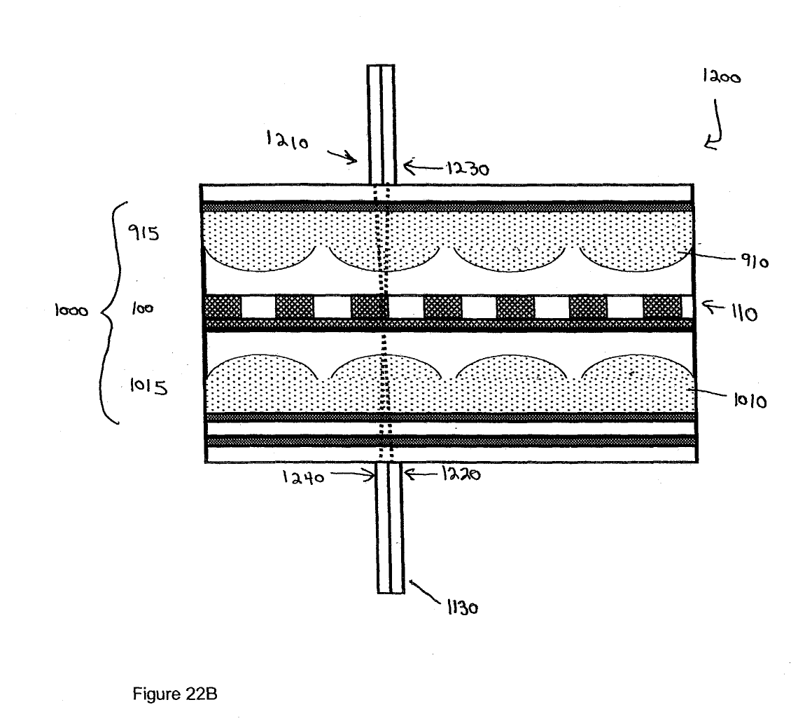

Referring now also to FIGS. 22A and B, there is shown a perspective view and a cross sectional view, respectively, of a device 1200 incorporating device 1100 and 1000 of FIGS. 21 and 20, respectively. Device 1200 may include a two dimensional array of fibers 1100 and a resonant mirror 100 is shown. Depicted in FIGS. 22A and B there is a finished multilayer PBS/C array 1200 with fibers 1130 substantially aligned to a corresponding lens 915 of array 910 in a telecentric mode. Lens 1010 array 1015 may be included and substantially aligned to a corresponding lens 915 of array 910 in a telecentric mode on the distal side of resonant mirror 100 from array 915. Resonant mirror 100 may be located at the focal plane of micro-lens array 910 as discussed hereinabove.

Operationally, for example, PBS/C device 1200 may function as shown in FIG. 22B, wherein input unpolarized transmissions impinge upon resonant mirror 100 via fiber 1210. Based on the discussion herein above, particularly for FIGS. 1-3, polarization selection may occur at pattern of nanostructures 110 within resonant mirror 100. The transmission incident on pattern of nanostructures 110 from fiber 1210 may interact with pattern of nanostructures 110 based on the wavelength and polarization state of the transmission. As shown, for example, pattern of nanostructures 110 may transmit the TM polarization component, in fiber 1220 for example, and reflect the TE polarization component, in fiber 1230 in FIG. 22B. The TE polarization component reflected may be the drop portion of PBS/C 1200. Additionally, as shown in FIG. 22B, an additional fiber 1240 may inject one or more transmissions of polarization TE from the distal end of resonant mirror 100 from fiber 1210. As resonant mirror 100 reflects TE polarized transmission, substantially all of the transmission injected using fiber 1240 may be reflected and collected in fiber 1220 as fiber 1240 is injecting TE polarized transmission. Thus a polarizing beam splitter and combiner is advantageously achieved.

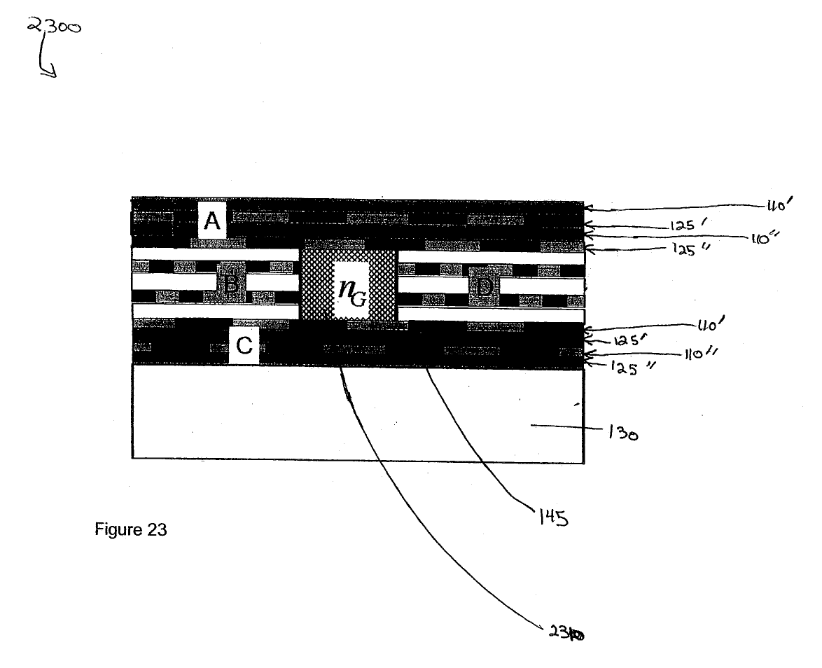

Referring now to FIG. 23, there is shown a guiding device according to an aspect of the present invention. Guiding device 2300 may include a waveguiding core 2310, and four distinct regions (A-D), aligned on a substrate 130. Region C is located substantially adjacent to substrate 130. Waveguiding core 2310 may be located substantially adjacent to Region C distal to substrate 130. Region A may be located substantially adjacent to core 2310 distal to Region C. Region B may be located substantially adjacent to core 2310 and substantially between Region A and Region C. Similarly, Region D may be located substantially adjacent to core 2310 distal to Region B and substantially between Region A and Region C.

Each region, A-D, may include an assembly of alternating layers of 110″, 125′, 110″, and 125″ as described hereinabove with respect to at least FIG. 16. Region A and Region C may have similar periods or different periods; they also may be formed of the same materials or varied materials. Region B and Region D may have similar periods or different periods; they also may be the same materials or varied materials. Each region, A-D, may include the same numbers of layers or may have different numbers of layers.

According to an aspect of the present invention, guiding device 2300 may have Region A and Region C having relatively similar periods and Region B and Region D having relatively similar periods, and Region A and Region B having relatively different periods. The period for Region B and Region D may be determined with n_{B,D} being the effective refractive index for Region B and Region D, respectively. λ_{center} may be the center wavelength of the operational band of core 2310, and m is an integer, such as, for example, unity. The period for Region B and Region D (Λ_{B,D}) may be determined by:

Λ_{B,D}D=m*λ_{center}/(2*n_{B,D})

According to an aspect of the present invention, the period of Region B and Region D may be substantially half of the period of Region A and Region C. Guiding device 2300 may be designed to confine traversing electromagnetic waves using principles of Bragg reflection. Further, guiding device 2300 may be employed to remove portions of traversing electromagnetic radiation.

Those of ordinary skill in the art may recognize that many modifications and variations of the present invention may be implemented without departing from the spirit or scope of the invention. Thus, it is intended that the present invention cover the modification and variations of this invention provided they come within the scope of the appended claims and their equivalents.

What is claimed is:

1. A device for reflecting at least a portion of a select polarization of at least one electromagnetic transmission having a given central wavelength impinging upon said device at a given acceptance angle, said device comprising:
a substrate; and,
at least two layers of nanostructures forming a resonant pattern on said substrate and adapted to define a plurality of high contrast refractive index interfaces being suitable for substantially reflecting at least a portion of said select polarization of said at least one transmission.

2. The device of claim 1, wherein said given incident angle is greater than or equal to zero.

3. The device of claim 1, wherein said given incident angle is greater than 2.5 degrees.

4. The device of claim 1, wherein said given incident angle is greater than five degrees.

5. The device of claim 1, wherein a polarization orthogonal to said select polarization of said at least one transmission is substantially transmitted by said device.

6. The device of claim 1, wherein a polarization orthogonal to said select polarization of said at least one transmission is substantially reflected by one of said at least two layers of nanostructures.

7. The device of claim 1, wherein the device further comprises a cladding layer positioned substantially adjacent to at least one of said at least two layers of nanostructures substantially distal to said substrate.

8. The device of claim 7, wherein said cladding layer and said substrate have substantially similar refractive indices.

9. The device of claim 8, wherein said substrate includes a first portion and a second portion, wherein said first portion has a substantially similar refractive index to said cladding layer.

10. The device of claim 9, wherein said second portion and said first portion have substantially the same refractive indices.

11. The device of claim 10, wherein the refractive index of said second portion and the refractive index of said first portion are measurably different.

12. The device of claim 7, further comprising at least one coating operably coupled to at least one of said at least two layers and being adapted to at least partially mitigate transmission losses.

13. The device of claim 12, wherein said at least one coating is substantially adjacent to said cladding layer.

14. The device of claim 12, wherein said at least one coating is substantially adjacent to said substrate.

15. The device of claim 12, wherein said at least one coating includes a coating substantially adjacent to said cladding layer and at least one coating substantially adjacent to said substrate.

16. The device of claim 7, further comprising at least one residual layer between said substrate and said cladding and having a substantially similar refractive index to at least one of said at least two layers of nanostructures.

17. The device of claim 1, further comprising a plurality of micro-lenses formed into an array substantially aligned with said resonant pattern.

18. The device of claim 17, wherein said micro-lenses have a substantially uniform pitch size.

19. The device of claim 17, wherein said micro-lenses have a substantially varied pitch size.

20. The device of claim 17, wherein said micro-lens array comprises at least one of a refractive, diffractive and hybrid array.

21. The device of claim 17, wherein said layer of nanostructures is positioned such that each of the plurality of lenses of said array focuses on a corresponding portion of said layer of nanostructures.

22. The device of claim 21, wherein the refractive index of said micro-lenses is substantially similar to the refractive index of said substrate.

23. The device of claim 17, further comprising at least a second micro-lens array aligned with at least one of said at least two layers of nanostructures.

24. The device of claim 23, wherein the refractive index of said second microlens array is substantially different from the refractive index of said substrate.

25. The device of claim 23, wherein at least one of said at least two layers of nanostructures is positioned such that each of said second micro-lenses focuses on a corresponding portion of at least one of said at least two layers of nanostructures.

26. The device of claim 25, further comprising at least one pair of optical fibers being suitable for use with said at least one transmission, wherein said pair of fibers is optically coupled to at least one of said micro-lenses of said first array.

27. The device of claim 25, further comprising at least two arrays of pairs of optical fibers, wherein a first pair of said fibers is optically coupled to said first micro-lenses in said first array and a second pair of fibers is optically coupled to a second of said micro-lenses in said second array.

28. The device of claim 27, wherein said fibers are polarization maintaining.

29. A lasing structure being suitable for providing output of at least one given wavelength, said structure comprising a plurality of reflective surfaces, at least one of said surfaces comprising at least two layers of nanostructures forming a resonant pattern on said substrate and defining a plurality of high contrast refractive index interfaces suitable for reflecting said select polarization of said at least one transmission.

30. The lasing structure of claim 29, further comprising a cavity formed between said plurality of reflective surfaces.

31. The lasing structure of claim 30, wherein each of said plurality of reflective surfaces comprises a layer of nanostructures forming a resonant pattern on said substrate adapted to define a plurality of high contrast refractive index interfaces adapted to reflect said select polarization of said at least one transmission.

32. The lasing structure of claim 31, wherein said structure forms a vertical cavity surface emitting laser.

33. The lasing structure of claim 31, wherein said plurality of reflective surfaces reflect at least one polarization of said output resonating within said cavity.

34. The lasing structure of claim 33, wherein a reflectivity of said reflector associated with said select polarization of said at least one transmission is slightly less than 1, thereby allowing a portion of said resonating said select polarization of at least one transmission be transmitted.

35. The lasing structure of claim 34, wherein said pattern comprises at least one of holes, strips, trenches and pillars.

36. The lasing structure of claim 35, wherein said structure is of the form of a type III-V semiconductor compound band vertical-cavity surface emitting laser.

37. The lasing structure of claim 30, wherein said cavity is defined by an oxide/insulator confinement boundary.

38. The lasing device of claim 31, further comprising at least one coating substantially adjacent to at least one of said reflective surfaces and adapted to at least partially mitigate transmission losses.

39. A method for forming a device for reflecting a select polarization of at least one transmission having a given wavelength, said method comprising:
forming a substrate including a surface for receiving a layer of nanostructures; and,
overlaying a film adapted to receive a replication on said surface of said substrate and replicating a pattern of nanostructures in said overlayed film and processing to thereby form a layer of nanostructures in said substrate.

40. The method of claim 39, further comprising applying a cladding layer substantially adjacent to a surface of said layer of nanostructures substantially distal to said substrate.

41. The method of claim 40, further comprising applying at least one coating substantially adjacent to said cladding layer.

42. The method of claim 40, further comprising applying at least one coating substantially adjacent to a surface of said substrate substantially distal to said cladding layer.

43. The method of claim 40, further comprising including a residual layer substantially adjacent to said substrate and substantially adjacent to said layer of nanostructures.

44. The method of claim 40, further comprising building a confinement boundary formed substantially adjacent to said substrate and adapted to form a cavity with said substrate substantially forming a closure on one end of said cavity.

45. The method of claim 44, further comprising forming a second substrate incorporated to form a closure on an end of said cavity opposite said one end.

46. The method of claim 45, further comprising applying a second layer of nanostructures on said second substrate.

47. The method of claim 45, further comprising enhancing reflection of said select polarization of at least one transmission by orienting said first substrate and said second substrate.

48. The method of claim 40, further comprising substantially aligning a first array including a plurality of micro-lenses in a telecentric mode with said layer of nanostructures.

49. The method of claim 48, further comprising substantially aligning a second array including a plurality of micro-lenses in a telecentric mode with said layer of nanostructures.

50. The method of claim 49, further comprising aligning a first pair of a plurality of fibers adjacent to said first array and a second pair of said plurality of fibers adjacent to said second array, said first pair and said second pair aligned in a telecentric mode.

51. A device for polarization independent reflecting of at least one transmission having a given wavelength impinging upon said device, said device comprising:
a substrate; and,
at least two layers of nanostructures forming a resonant pattern on said substrate adapted to define a plurality of high contrast refractive index interfaces suitable for polarization independently substantially reflecting said at least one transmission.

52. The device of claim 51, wherein the device further comprises a cladding layer positioned substantially adjacent to at least one of said at least two layers of nanostructures substantially distal to said substrate.

53. The device of claim 52, wherein said cladding layer and said substrate have substantially similar refractive indices.

54. The device of claim 53, wherein said substrate includes a first portion and a second portion, wherein said first portion has a substantially similar refractive index to said cladding layer.

55. The device of claim 54, wherein said second portion and said first portion have substantially the same refractive indices.

56. The device of claim 55, wherein the refractive index of said second portion and the refractive index of said first portion are measurably different.

57. The device of claim 52, further comprising at least one coating operably coupled to said layer and adapted to at least partially mitigate transmission losses.

58. The device of claim 57, wherein said at least one coating is substantially adjacent to said cladding layer.

59. The device of claim 57, wherein said at least one coating is substantially adjacent to said substrate.

60. The device of claim 57, wherein said at least one coating includes a coating substantially adjacent to said cladding layer and at least one coating substantially adjacent to said substrate.

61. The device of claim 52, further comprising at least one residual layer between said substrate and said cladding and having a substantially similar refractive index with at least one of said at least two layers of nanostructures.

62. A device for waveguiding electromagnetic radiation a given wavelength through a core, said device comprising:
a substrate;
a first region of at least two layers of nanostructures forming a resonant pattern on said substrate adapted to define a plurality of high contrast refractive index interfaces suitable for substantially reflecting said select polarization of said at least one transmission, said first region aligned substantially between the core and said substrate;
a second region of at least two layers of nanostructures forming a resonant pattern aligned substantially adjacent to the core distal to said first region;
a third region of at least two layers of nanostructures forming a resonant pattern aligned substantially adjacent to the core and substantially between said first and said second regions; and,
a fourth region of at least two layers of nanostructures forming a resonant pattern aligned substantially adjacent to the core distal to said third region and substantially between said first and said second regions.

63. The device of claim 62, wherein said first and said second regions have substantially the same period.

64. The device of claim 63, wherein said third and said fourth regions have substantially the same period.

65. The device of claim 64, wherein said period of said first and said second regions is approximately twice the period of said third and fourth regions.
